(19) United States
(12) Patent Application Publication
(10) Pub. No.: US 2008/0158159 A1
(43) Pub. Date: Jul. 3, 2008

(54) ON-SCREEN CURSOR NAVIGATION ON A HANDHELD COMMUNICATION DEVICE DISPLAYING A MODIFED WEBPAGE

(75) Inventors: Matthew Richard LEE, Belleville (CA); Fahd Sohail BUTT, Mississauga (CA); Taneem TALUKDAR, Kingston (CA)

Correspondence Address: NOVAK DRUCE + QUIGG LLP (RIM), 1000 LOUISIANA STREET, FIFTY-THIRD FLOOR, HOUSTON, TX, 77002, US

(73) Assignee: RESEARCH IN MOTION LIMITED, Waterloo (CA)

(21) Appl. No.: 11/617,860

(22) Filed: Dec. 29, 2006

(51) Int. Cl. G06F 3/033

(52) U.S. Cl. 345/167; 345/157; 345/168

(57) ABSTRACT

A handheld communication device and method for affecting movement of a highlighting cursor amongst a lighted display capable of displaying a webpage is described. The webpage has a native form including a number of user-actuable links related in series. The webpage displayable on the handheld communication device is modified from its native form so as to be displayed on the lighted display. The modified webpage retains the series relationship between the user-actuable links. A non-directionally limited auxiliary user input is located essentially between the lighted display and the keyboard and is capable of affecting non-serial movement of the highlighting cursor amongst the user-actuable links.

A portion of the disclosure of this patent document contains material which is subject to copyright protection. The copyright owner has no objection to the facsimile reproduction by any one of the patent document or patent disclosure as it appears in the Patent and Trademark Office patent file or records, but otherwise reserves all copyright rights whatsoever.

### FIELD

The present disclosure is directed toward handheld communication devices, and more particularly, to navigation among user-actuable links displayed on a display screen of a handheld communication device.

### BACKGROUND

With the advent of more robust wireless communications systems, compatible handheld communication devices are becoming more prevalent, as well as advanced. In a broader sense, these devices are referred to as handheld electronic devices, which include devices without communication functions. Where in the past such handheld communication devices typically accommodated either voice (cell phones) or text transmission (pagers and PDAs), today's consumer often demands a combination device capable of performing both types of transmissions, including sending and receiving e-mail. The suppliers of such mobile communication devices and underlying service providers are anxious to meet these demands, but the combination of voice and textual messaging, as well as other functionalities such as those found in PDAs, have caused designers to have to improve the means by which information is input into the devices by the user, as well as provide better facilitation for the user to navigate within the webpages and/or menus and selectable link presentations necessary for efficient user interface with these more complicated devices.

For many reasons, user-actuable links are often utilized on webpages as a way to allow users to make selections to obtain further information. Among other reasons, users are accustomed to such user-actuable links for function selection. A prime example is the personal computer “desktop” presented by Microsoft's Windows® operating system and Internet Explorer®. Because of the penetration of such programs into the user markets, most electronics users are familiar with what has basically become a convention of selectable link-based functionality. Even with many user-actuable links presented on a personal computer's “browser” or “webpage”, however, user navigation and selection among the different selections is easily accomplished utilizing a conventional mouse and employing the point-and-click methodology. The absence of such a mouse from handheld wireless communication devices, however, has caused a different protocol to develop for selectable link navigation and selection.

As depicted in FIGS. 2a-2g, the user-actuable links displayed on a native webpage of an internet browser of a personal computer, for example, are typically presented in an array of horizontally and vertically oriented rows and columns. As an example, as shown in FIGS. 2a-2g, a native “Blackberry.com” webpage presents horizontally oriented user-actuable links for “Press Releases”, “Developers”, “Partners”, “Support”, “Careers”, and “Legal.” Accordingly, when using the “tab” button on most personal and laptop computers, a highlighting cursor can be used to navigate to successive and/or serial user-actuable links horizontally arranged on the display to form a row. Accordingly, each successive assertion of the “tab” button causes the highlighting cursor to navigate to a successive horizontally oriented selectable link. While this type of navigation is sufficient for accomplishing its intended task, a problem arises when such webpage is modified to fit upon the smaller screen of a handheld communications device.

More specifically, as shown in FIGS. 3a-3g, in order for the “Blackberry.com” webpage to fit upon the lighted display of a handheld device, several of the previously horizontally oriented and serial user-actuable links of the native webpage must be “wrapped” to the next row in order to be vertically arranged. While this, in and of itself, is not problematic, the now vertically appearing user-actuable links, nonetheless, retain their serial horizontal selectability. An example of a wrapped webpage on a handheld device is more clearly illustrated in FIGS. 3a-3g, which shows that a formerly single row of user-actuable links from the native webpage, i.e., “Press releases”, “Developers”, “Partners”, “Support”, “Careers”, and “Legal”, have been wrapped and rearranged to form a pair of rows; a first row containing user-actuable links labeled “Press Releases”, “Developers”, “Partners”, and “Support”, and a second row containing user-actuable links labeled “Careers”, and “Legal”. Accordingly, because the wrapped modification of the webpage retains the horizontal serial relationship of the user-actuable links, as shown in FIGS. 3b-3d, in order for a user to navigate from the selectable link labeled “Press Releases”, disposed in a first row, to the selectable link labeled “Legal” on a second row, using, for example, a handheld communication device comprising a thumbwheel, the user must scroll through a number of undesired user-actuable links, such as “Developers” or “Partners”, that remain horizontally disposed relative to one another. That is, the user cannot directly vertically navigate between the first row and the second row due to the “wrapping.” Accordingly, in the case wherein a wrapped webpage comprises a large number of horizontally oriented links, it can take a significant amount of time and effort for a user to scroll to a desired selectable link. Consequently, the above described condition can be frustrating to users.

Accordingly, the instantly presented solutions focus on enabling a user to directly navigate a highlighting cursor between rows of horizontal and serially oriented links on a modified webpage using a non-directionally limited auxiliary user input.

### BRIEF DESCRIPTION OF THE DRAWINGS

Exemplary methods and arrangements conducted and configured according to the advantageous solutions presented herein are depicted in the accompanying drawings wherein:

FIG. 1 depicts a handheld communication device cradled in the palm of a user's hand;

FIG. 2a depicts a native webpage displayed on a display of a personal computer;

FIG. 2b depicts a native webpage displayed on a display of a personal computer wherein a highlighting cursor has been tabbed to highlight a selectable link labeled “Press Releases”;

FIG. 2c depicts a native webpage displayed on a display of a personal computer wherein a highlighting cursor has been tabbed to highlight a selectable link labeled “Developers”;

FIG. 2d depicts a native webpage displayed on a display of a personal computer wherein a highlighting cursor has been tabbed to highlight a selectable link labeled “Partners”;

FIG. 2e depicts a native webpage displayed on a display of a personal computer wherein a highlighting cursor has been tabbed to highlight a selectable link labeled “Support”;

FIG. 2f depicts a native webpage displayed on a display of a personal computer wherein a highlighting cursor has been tabbed to highlight a selectable link labeled “Careers”;

FIG. 2g depicts a native webpage displayed on a display of a personal computer wherein a highlighting cursor has been tabbed to highlight a selectable link labeled “Legal”;

FIG. 3a depicts a known handheld communication device cradled in a user's hand and displaying a modified webpage wherein a highlighting cursor has been moved to highlight a selectable link labeled “Blackberry for Life”;

FIG. 3b depicts a known handheld communication device cradled in a user's hand and displaying a modified webpage wherein a highlighting cursor has been moved to highlight a selectable link labeled “Press Releases”;

FIG. 3c depicts a known handheld communication device cradled in a user's hand and displaying a modified webpage wherein a highlighting cursor has been moved to highlight a selectable link labeled “Developers”;

FIG. 3d depicts a known handheld communication device cradled in a user's hand and displaying a modified webpage wherein a highlighting cursor has been moved to highlight a selectable link labeled “Partners”;

FIG. 3e depicts a known handheld communication device cradled in a user's hand and displaying a modified webpage wherein a highlighting cursor has been moved to highlight a selectable link labeled “Support”;

FIG. 3f depicts a known handheld communication device cradled in a user's hand and displaying a modified webpage wherein a highlighting cursor has been moved to highlight a selectable link labeled “Careers”;

FIG. 3g depicts a known handheld communication device cradled in a user's hand and displaying a modified webpage wherein a highlighting cursor has been moved to highlight a selectable link labeled “Legal”;

FIG. 4a depicts a novel handheld communication device cradled in a user's hand and displaying a modified webpage wherein a highlighting cursor has been moved to highlight a selectable link labeled “Blackberry for Life”;

FIG. 4b depicts a novel handheld communication device cradled in a user's hand and displaying a modified webpage wherein a highlighting cursor has been moved to highlight a selectable link labeled “Press Releases”;

FIG. 4c depicts a novel handheld communication device cradled in a user's hand and displaying a modified webpage wherein a highlighting cursor has been moved to highlight a selectable link labeled “Support”;

FIG. 4d depicts a novel handheld communication device cradled in a user's hand and displaying a modified webpage wherein a highlighting cursor has been moved to highlight a selectable link labeled “Legal”;

FIG. 5 is an exploded perspective view of an exemplary wireless handheld electronic device incorporating a trackball assembly as at the auxiliary user input;

FIG. 6 illustrates an exemplary QWERTY keyboard layout;

FIG. 7 illustrates an exemplary QWERTZ keyboard layout;

FIG. 8 illustrates an exemplary AZERTY keyboard layout;

FIG. 9 illustrates an exemplary Dvorak keyboard layout;

FIG. 10 illustrates a QWERTY keyboard layout paired with a traditional ten-key keyboard;

FIG. 11 illustrates ten digits comprising the numerals 0-9 arranged in a telephone keypad configuration, including the * and # flanking the zero;

FIG. 12 illustrates a numeric phone key arrangement according to the ITU Standard E.161 including both numerals and letters;

FIG. 13 is a front view of an exemplary handheld electronic device including a full QWERTY keyboard;

FIG. 14 is a front view of another exemplary handheld electronic device including a full QWERTY keyboard;

FIG. 15 is a front view of an exemplary handheld electronic device including a reduced QWERTY keyboard;

FIG. 16 is a detail view of the reduced QWERTY keyboard;

FIG. 17 is a detail view of an alternative reduced QWERTY keyboard; and

FIG. 18 is a block diagram representing a wireless handheld communication device interacting in a communication network.

### DETAILED DESCRIPTION

As intimated hereinabove, one of the more important aspects of the handheld electronic device to which this disclosure is directed is its size. While some users will grasp the device in both hands, it is intended that a predominance of users will cradle the device in one hand in such a manner that input and control over the device can be affected using the thumb of the same hand in which the device is held, however addition control can be effected by using both hands. As a handheld device that is desirably pocketable, the size of the device must be kept relatively small. Of the device's dimensions, limiting its width is important for the purpose of assuring cradleability in a user's hand. Moreover, it is preferred that the width of the device be maintained at less than ten centimeters (approximately four inches). Keeping the device within these dimensional limits provides a hand cradleable unit that users prefer for its useability and portability. Limitations with respect to the height (length) of the device are less stringent when considering hand-cradleability. Therefore, in order to gain greater size, the device can be advantageously configured so that its height is greater than its width, but still remain easily supported and operated in one hand.

A potential problem is presented by the small size of the device in that there is limited exterior surface area for the inclusion of user input and device output features. This is especially true for the “prime real estate” on the front face of the device, where it is most advantageous to include a display screen that outputs information to the user. The display screen is preferably located above a keyboard that is utilized for data entry into the device by the user. If the screen is provided below the keyboard, a problem occurs in that viewing the screen is inhibited when the user is inputting data using the keyboard. Therefore it is preferred that the display screen be above the input area, thereby solving the problem by assuring that the hands and fingers do not block the view of the screen during data entry periods.

To facilitate textual data entry, an alphabetic keyboard is provided. In one version, a full alphabetic keyboard is utilized in which there is one key per letter (see FIG. 14 for an example). This is preferred by some users because it can be arranged to resemble a standard keyboard with which they are most familiar. In this regard, the associated letters can be advantageously organized in QWERTY, QWERTZ, AZERTY or Dvorak layouts, among others, thereby capitalizing on certain users' familiarity with these special letter orders. In order to stay within the bounds of a limited front surface area, however, each of the keys must be commensurately small when, for example, twenty-six keys must be provided in the instance of the English language. An alternative configuration is to provide a reduced keyboard in which at least some of the keys have more than one letter associated therewith (see FIG. 17 for an example). This means that fewer keys are required which makes it possible for those fewer keys to each be larger than in the instance when a full keyboard is provided on a similarly dimensioned device. Some users will prefer the solution of the larger keys over the smaller ones, but it is necessary that software or hardware solutions be provided in order to discriminate which of the several associated letters the user intends based on a particular key actuation, a problem the full keyboard avoids. Preferably, this character discrimination is accomplished utilizing disambiguation software included on the device. To accommodate software use on the device, a memory and microprocessor are provided within the body of the handheld unit for receiving, storing, processing, and outputting data during use. Therefore, the problem of needing a textual data input means is solved by the provision of either a full or reduced alphabetic keyboard on the presently disclosed handheld electronic device. It should be further appreciated that the keyboard can be alternatively provided on a touch sensitive screen in either a reduced or full format.

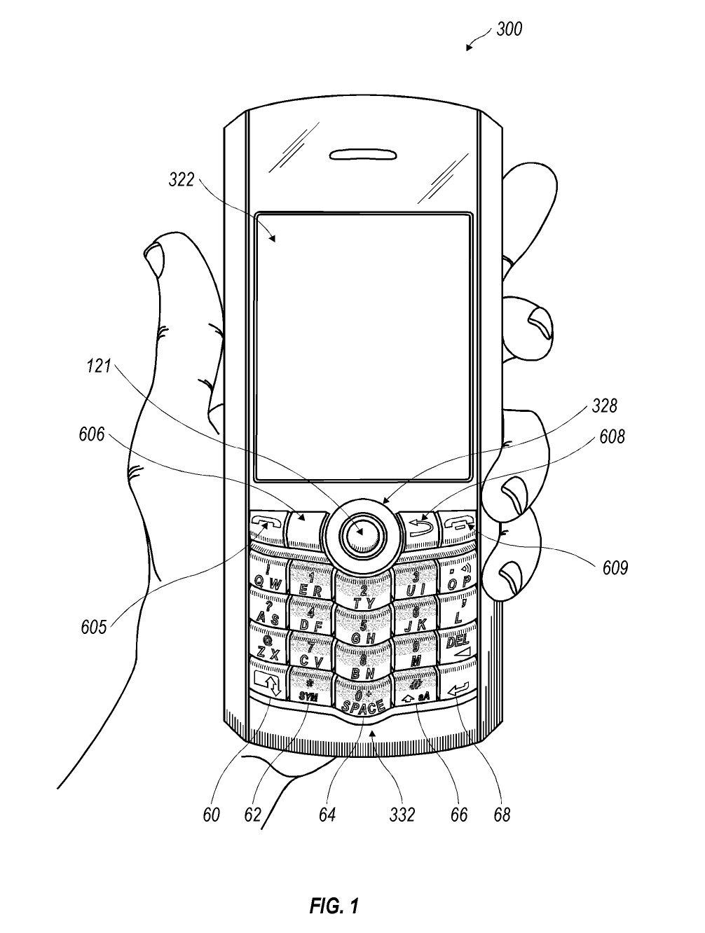

Keys, typically of a push-button or touchpad nature, perform well as data entry devices but present problems to the user when they must also be used to affect navigational control over a screen-cursor. In order to solve this problem, the present handheld electronic device preferably includes an auxiliary input that acts as a cursor navigational tool and which is also exteriorly located upon the front face of the device. Its front face location is particularly advantageous because it makes the tool easily thumb-actuable like the keys of the keyboard. In a particularly useful embodiment, the navigational tool is a trackball which is easily utilized to instruct two-dimensional screen cursor movement in substantially any direction, as well as act as an actuator when the ball of the trackball is depressed like a button. The placement of the trackball is preferably above the keyboard and below the display screen; here, it avoids interference during keyboarding and does not block the user's view of the display screen during use (see FIG. 1 for an example).

In some configurations, the handheld electronic device may be standalone in that it does not connect to the “outside world.” One example would be a PDA that stores such things as calendars and contact information but is not capable of synchronizing or communicating with other devices. In most situations, such isolation will be viewed detrimentally in that synchronization is a highly desired characteristic of handheld devices today. Moreover, the utility of the device is significantly enhanced when connectable within a system, and particularly when connectable on a wireless basis in a network in which voice, text messaging, and other data transfer are accommodated.

In an embodiment, a handheld electronic communication device is programmed to permit substantially vertical user navigation on a display screen of the device across a plurality of serially associated, user-actuable links without progressing sequentially through the series of the user-actuable links. In such embodiment, the device includes a display screen having a width and a height, which is located above a keyboard suitable for accommodating textual input to the handheld communication device. A processor is programmed to display on the display screen, a viewable page including a plurality of serially associated user-actuable links. The serially associated user-actuable links have a display length that is greater than the width of the display screen and the processor is programmed to wrap the user-actuable links into a plurality of vertically stacked link segments that at least partially fit on the display screen for user viewing and actuation. An auxiliary user input device, capable of directing two-dimensional navigation on the display screen is provided and the processor is programmed to direct substantially vertical navigation of a cursor between vertically stacked, user-actuable links in response to a corresponding user request, input via the auxiliary user input device, without progressing sequentially through the series of user-actuable links.

In an embodiment, the auxiliary user input is one of a trackball, touchpad or joystick. In some embodiments, the user-actuable links are functionally horizontally serially associated with one another yet arranged in a vertical appearing relationship. In still yet some embodiments, the substantially vertical navigation is accomplished by asserting a longitudinally directed force upon the auxiliary user input device. In some embodiments, the handheld electronic device comprises an additional auxiliary input for accomplishing said substantially vertical navigation. In some embodiments, the additional auxiliary input is disposed proximate at least one of a top and bottom of said keyboard of said handheld communication device and/or the additional auxiliary input is a keyboard button. In some embodiments, the keyboard button is one of keyboard a button labeled “T” and “B.”

In an embodiment, a method for affecting substantially vertical user navigation on a display screen of an electronic handheld device across a plurality of serially associated, user-actuable links without progressing sequentially through the series of user-actuable links, wherein the electronic handheld device comprises a display screen, having a width and a height, located above a keyboard suitable for accommodating textual input to the handheld communication device, comprises programming a processor to display on the display screen, a viewable page comprising a plurality of serially associated user-actuable links. The serially associated user-actuable links have a display length greater than the width of the display screen and a programmed processor wraps the user-actuable links into a plurality of vertically stacked link segments that at least partially fit on the display screen for user viewing and actuation. The method further includes inputting a navigation request using an auxiliary user input device to direct two-dimensional navigation of a cursor on the display screen. The programmed processor directs substantial vertical navigation of the cursor between the vertically stacked, user-actuable links in response to the input, wherein the two-dimensional navigation occurs without progressing sequentially through the series of user-actuable links.

In an embodiment of the method, the auxiliary user input is a trackball. In an embodiment of the method, the user-actuable links are functionally horizontally serially associated with one another and arranged in vertical appearing relationship.

In some embodiments of the method, the substantially vertical navigation is accomplished by asserting a longitudinally directed force upon the auxiliary user input device. In some embodiments of the method, the handheld device comprises an additional auxiliary input for accomplishing the substantially vertical navigation. In still yet some embodiments, the additional auxiliary input is disposed proximate at least one of a top and bottom of said keyboard of the handheld communication device. In some embodiments, the additional auxiliary input is a keyboard button and is one of the keyboard buttons labeled “T” and “B.”

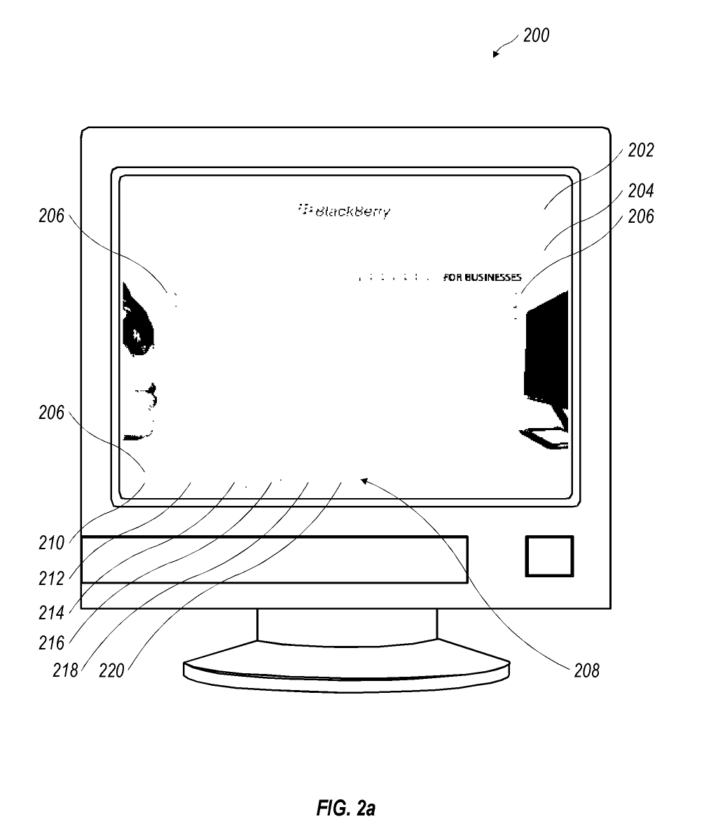

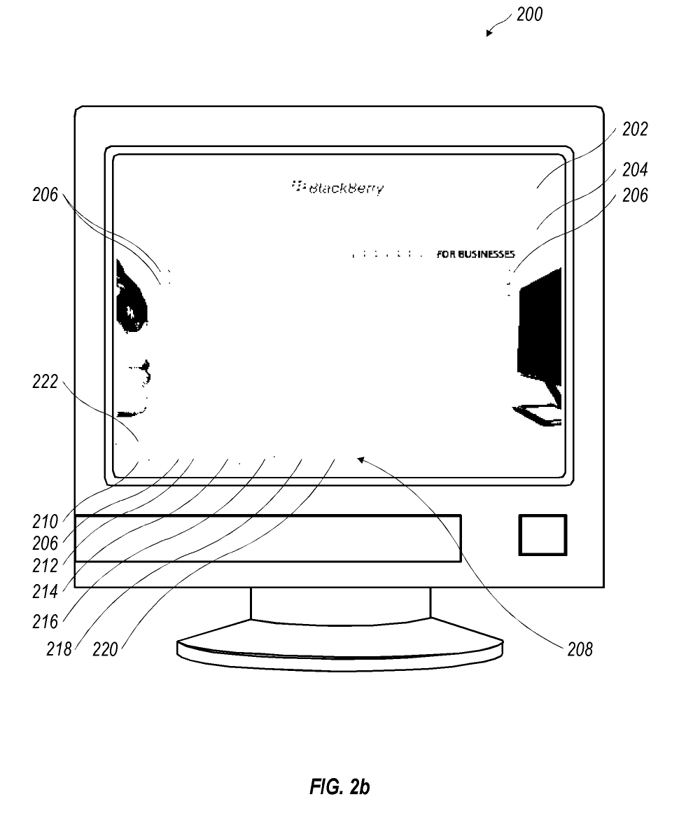

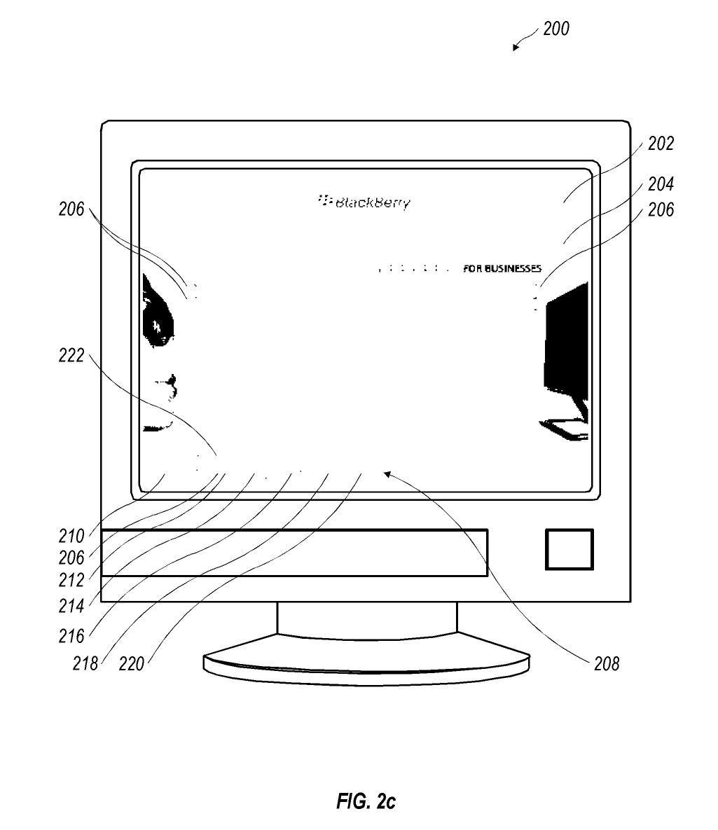

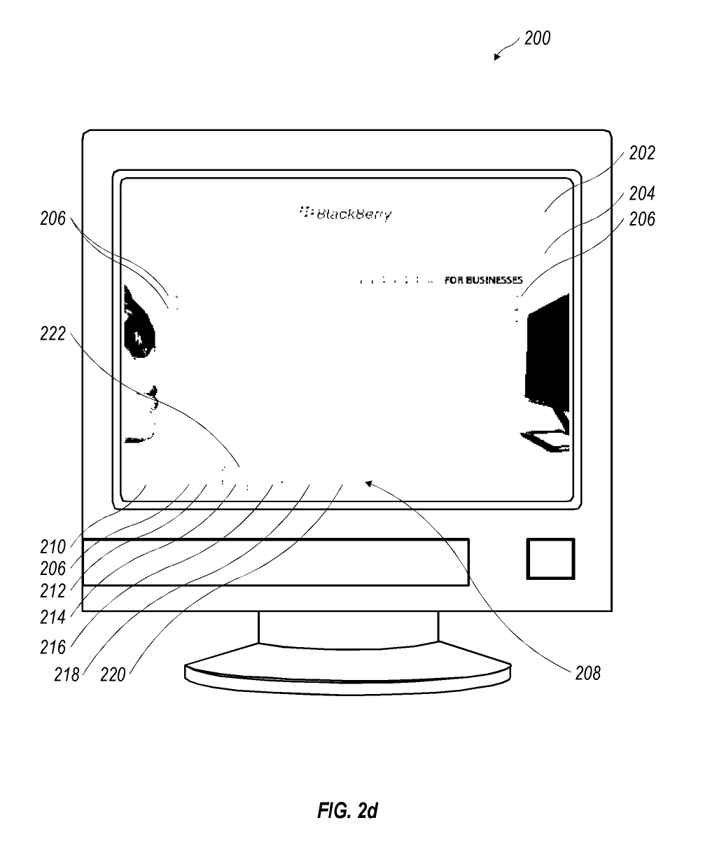

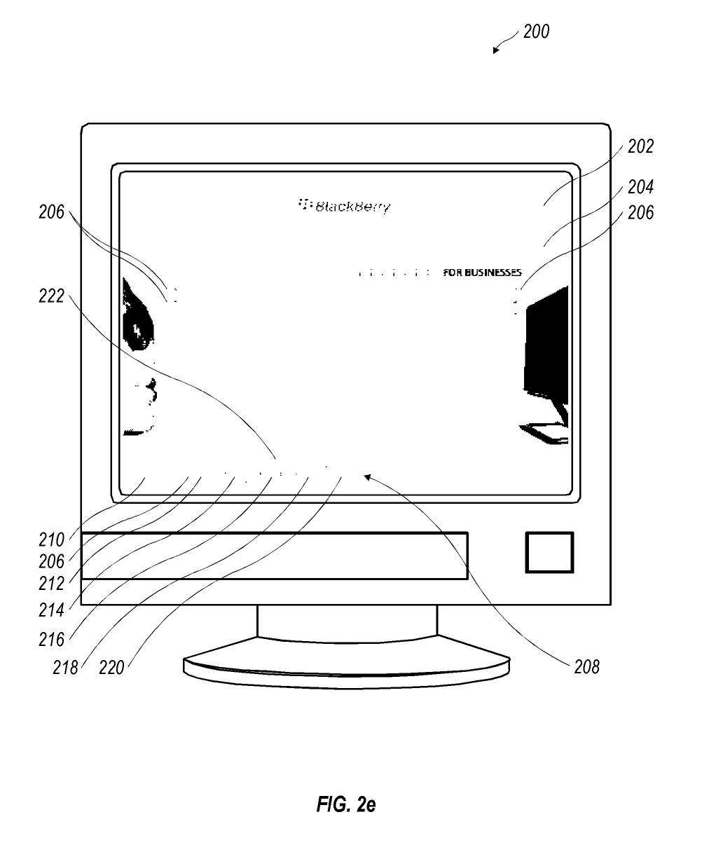

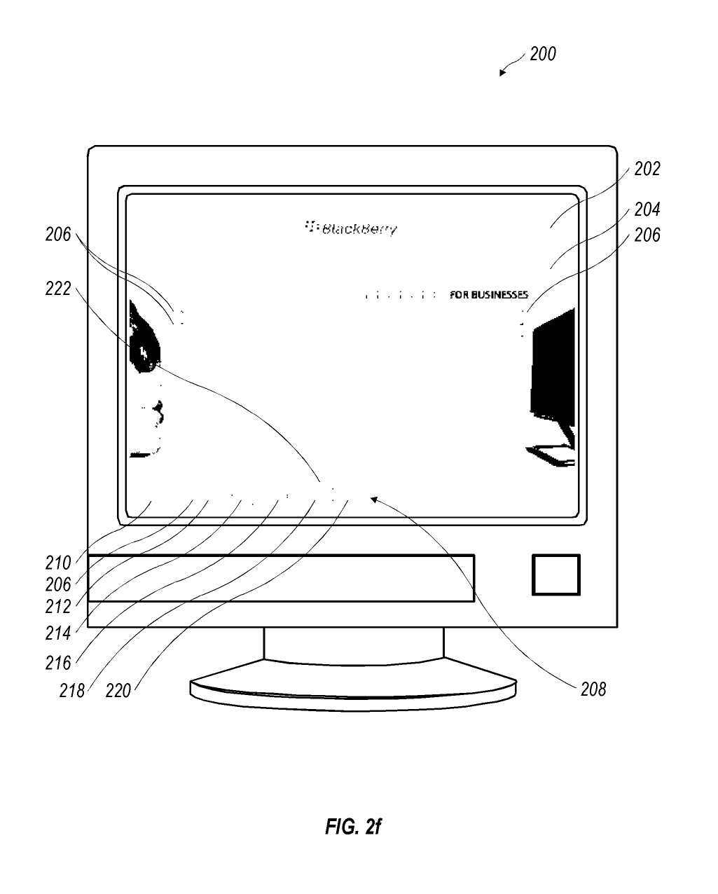

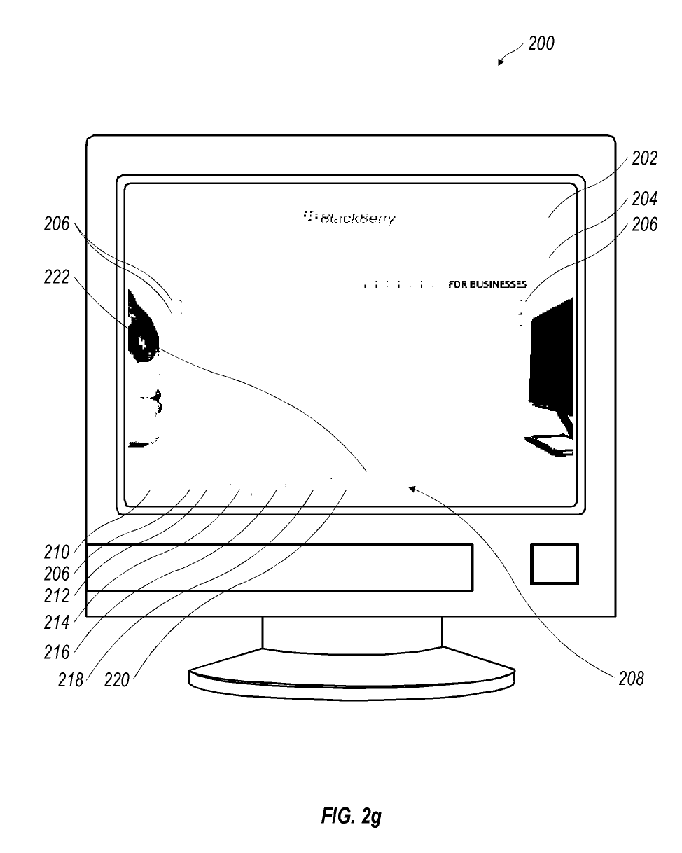

Referring now to FIGS. 2a-2g, which illustrates display 200 of a personal computer (not shown) having a “normal” or “full” size, an internet browser 202 is shown as displaying native webpage 204, which has a plurality of user-actuable links 206 arranged thereabout, including horizontally and serially oriented user-actuable links 208 located toward a lower portion of the webpage. In the native webpage, horizontally and serially oriented user-actuable links 208 form a single row. Horizontally and serially oriented user-actuable links 208 include links 210, 212, 214, 216, 218 and 220, labeled “Press Releases”, “Developers”, Partners”, Support”, “Careers” and “Legal” respectively. Lacking a mouse or similar type of “point and click” device, in order for a user to navigate to, and amongst, the horizontally and serially oriented user-actuable links 208, such user utilizes the “tab” button of a keyboard (not shown). Accordingly, as shown successively in FIGS. 2b2g, each successive assertion of the “tab” button (not shown) causes highlighting cursor 222 to serially navigate from selectable link 210, to selectable link 212, to selectable link 214, and ultimately to selectable link 220 with further assertions of the “tab” button.

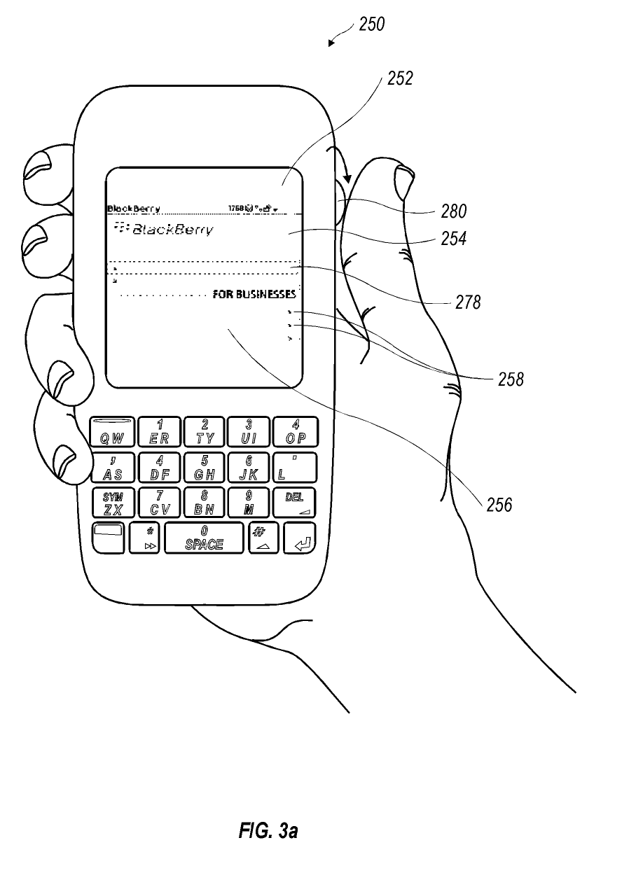

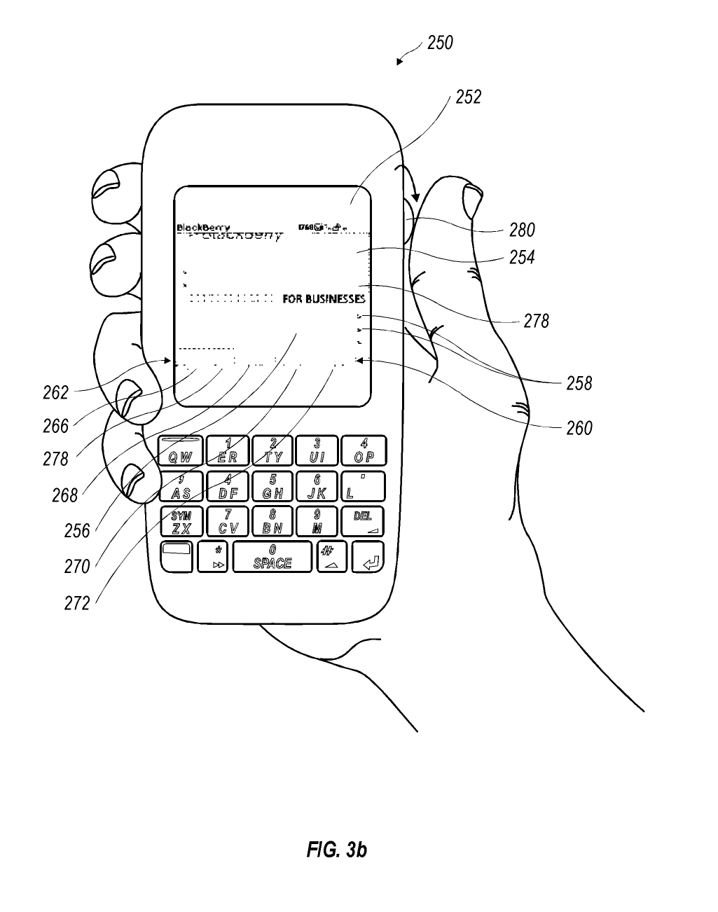

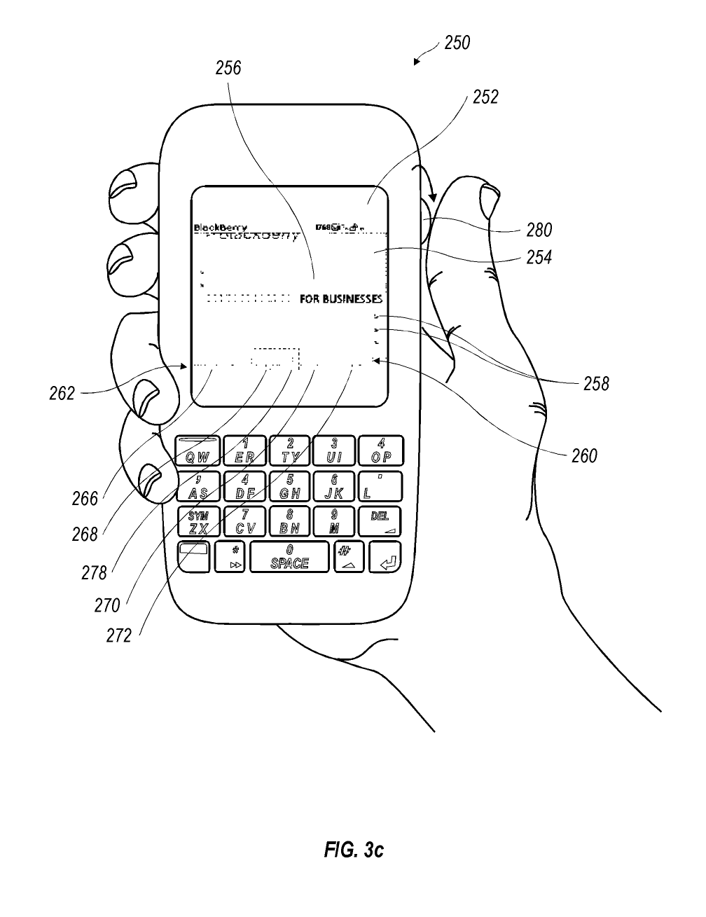

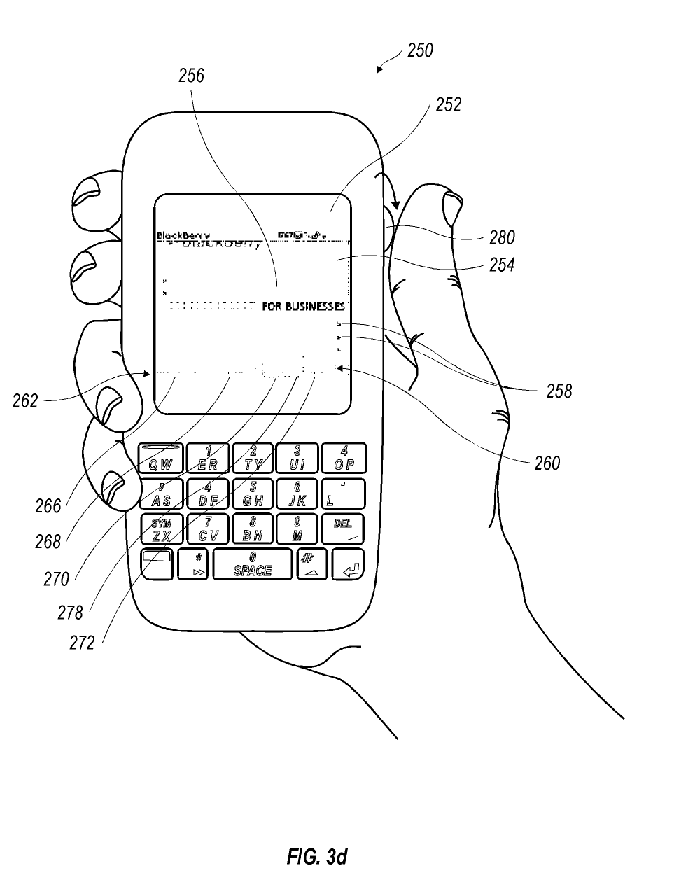

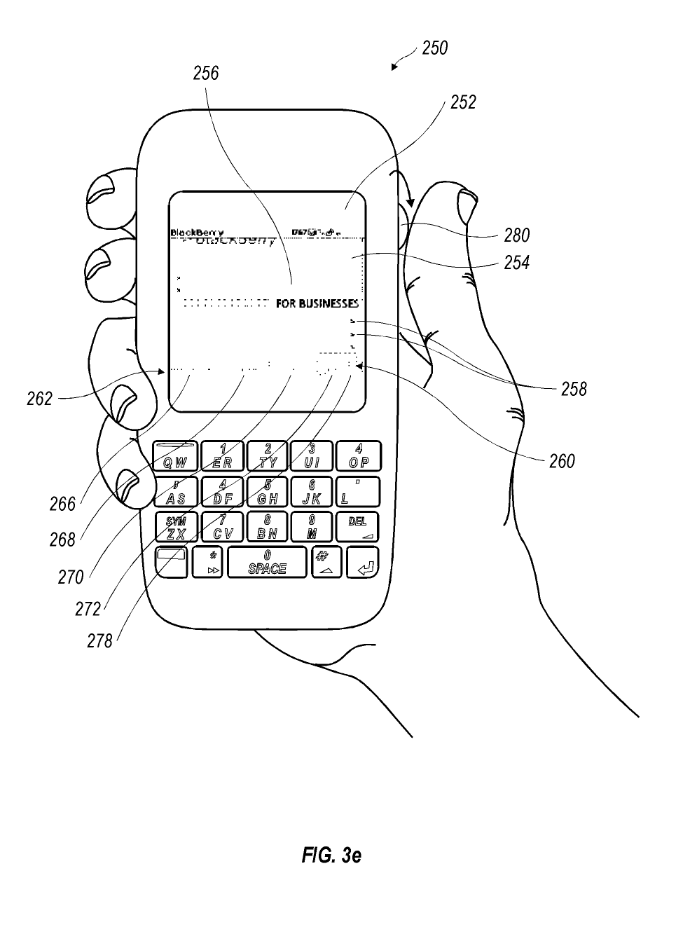

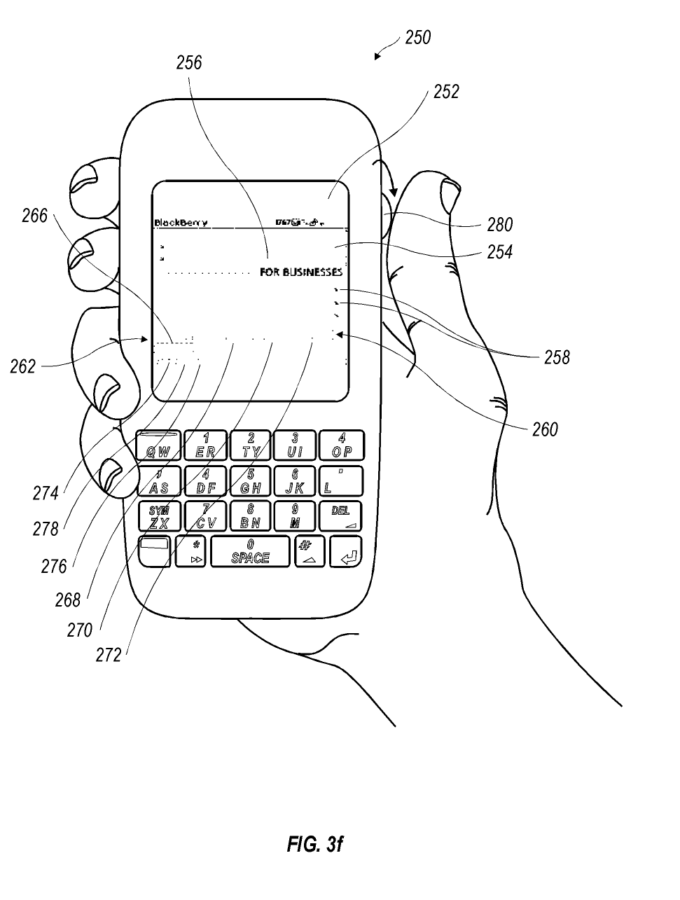

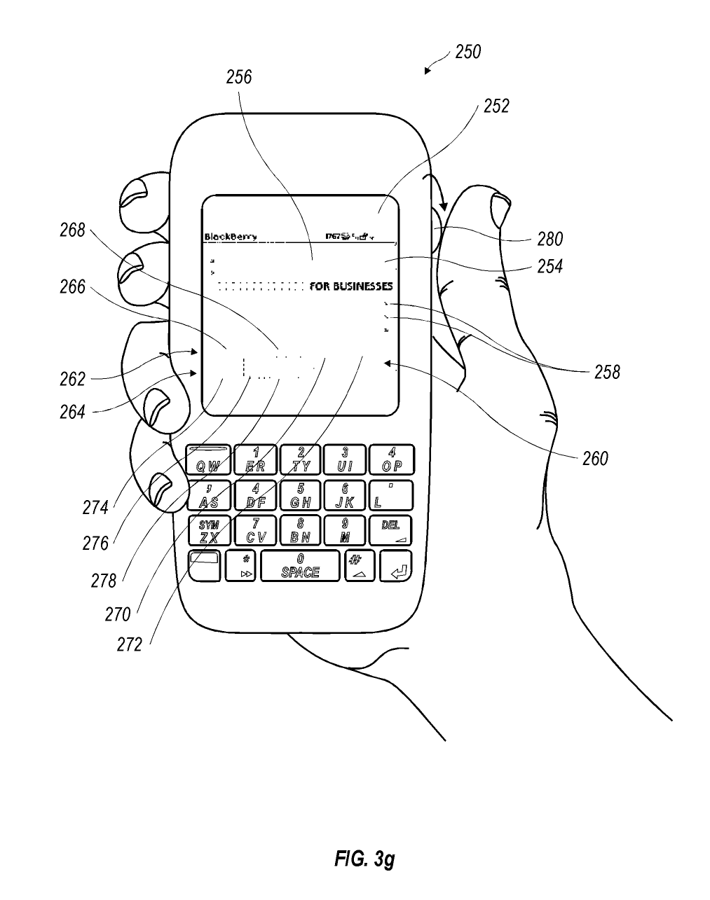

Referring now to FIGS. 3a-3g, which illustrate display 252 of a handheld electronic device 250 as being smaller relative to the display 200 of personal computer; an internet browser 254 is shown as displaying modified webpage 256, which has been modified from its native form to fit on display 252. Modified webpage 256 includes a plurality of user-actuable links 258 arranged thereabout, including horizontally and serially oriented user-actuable links 260 located toward a lower portion of the webpage and forming first row 262 and second row 264. For accommodation upon the smaller display of the handheld electronic device, the single row of user-actuable links from the native webpage 204 have been “wrapped” to form a pair of rows, which have a vertically appearing relationship relative to one another. First row 262 is shown as consisting of horizontally and serially oriented user-actuable links 266, 268, 270, and 272, corresponding to “Press Releases”, “Developers”, “Partners”, “Support” labels, respectively. Second row 264 is shown as consisting of horizontally and serially oriented user-actuable links 274 and 274, corresponding to “Careers” and “Legal” labels, respectively.

Handheld device 250 is shown without a mouse or similar type of “point and click” device, and, accordingly, comprises rotatable thumbwheel 280 for navigating highlighting cursor 278 amongst the plurality of user-actuable links 258. Consequently, because a number of user-actuable links 258 of modified webpage 256 appear vertically oriented relative to one another, yet retain the horizontal and serial relationship of native webpage 204, in order for a user to navigate to, and amongst, the horizontally and serially oriented user-actuable links 260, e.g., as in first row 262 and second row 264, a user must rotate rotatable thumbwheel in an upward or downward direction to affect highlighting cursor 278 movement. Therefore, when each row of a pair of rows comprises a single selectable link, movement of the thumbwheel in the direction of the arrow will cause the highlighting link to directly move from one row to the next. However, in the case where first row 262 and second row 264 are disposed one above the other and each contain a plurality of links, when a user highlights link 266 (see FIG. 3b) in the first row and desires to navigate to link 276 in the second row (See FIG. 3g), the user must rotate thumbwheel 280 in the direction of the arrow such that highlighting cursor 278 moves rightward along the first row. Upon reaching link 272 at the end of the first row, continued rotation of the thumbwheel causes the highlighting cursor to be wrapped and passed to link 274 of the second row. Further rotation of the thumbwheel in the direction of the arrow ultimately moves the highlighting cursor to link 276. Accordingly, a user is required to successively pass and highlight each of link 268, 270, 272 and 274 in order to highlight link 276.

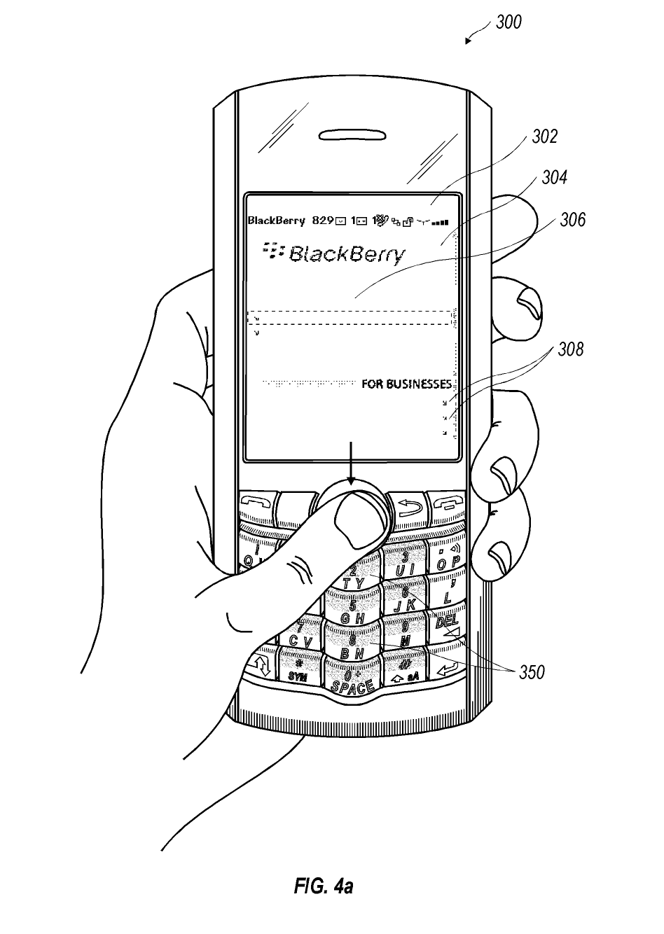

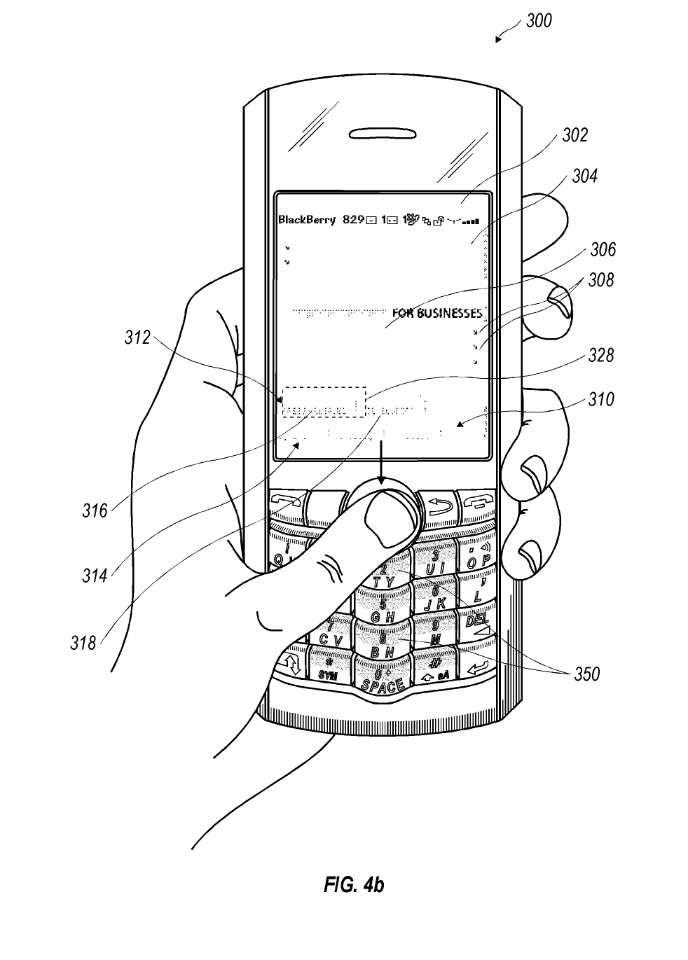

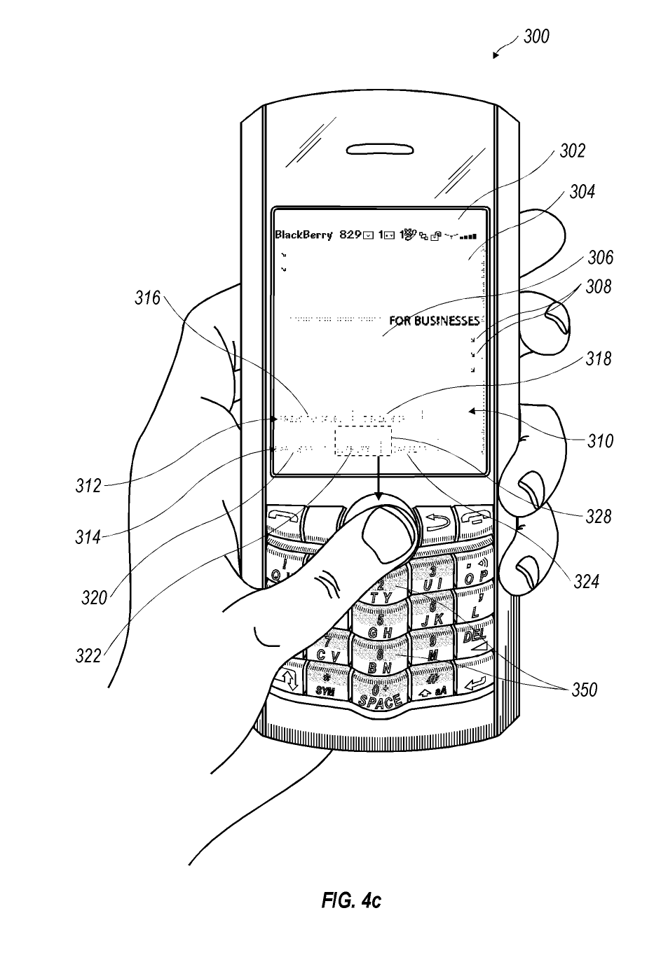

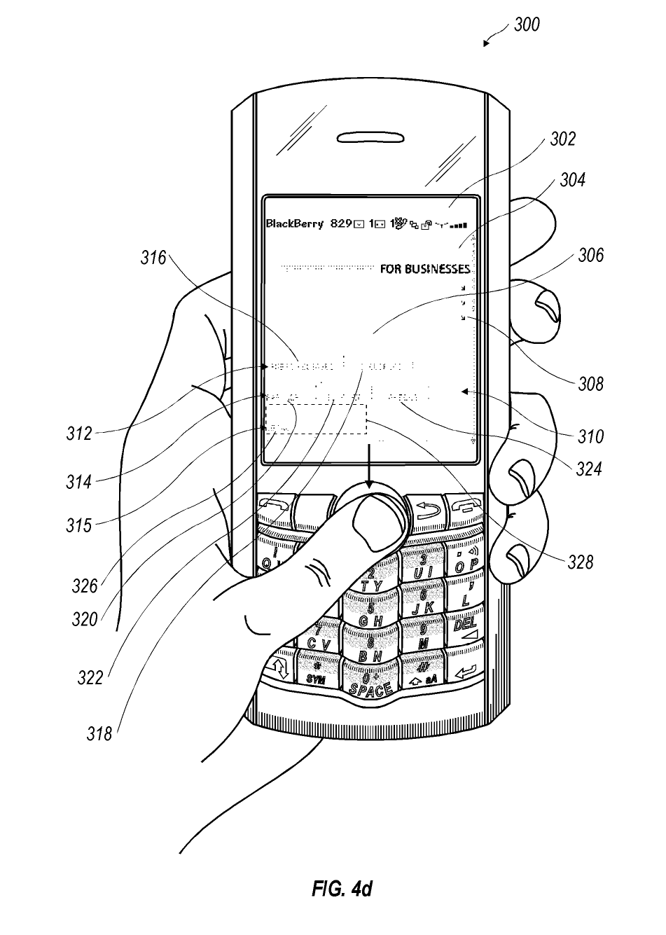

Referring now to FIGS. 1 and 4a-4d; as shown in FIG. 1, the novel handheld electronic device 300 is cradleable in the palm of a user's hand. The handheld electronic device is provided with a keyboard 332 to enter text data and place telephone calls and a display screen 322 for communicating information to the user. A connect/send key 605 is preferably provided to aid in the placement of a phone call. Additionally, a disconnect/end key 609 is provided. The send key 605 and end key 609 preferably are arranged in a row of keys including a navigation tool 328. Additionally, the row of keys including the navigation tool preferably has a menu key 606 and an escape key 608. The menu key 606 is used to bring up a menu and the escape key 608 is used to return to the previous screen or previous menu selection. As may be further appreciated from FIG. 1, the device 300 is of unibody construction, but it is also contemplated that the device may be of an alternative construction such as that commonly known as “clamshell” or “flip-phone” style. Regardless, in the operable configuration for the device 300, non-directionally limited auxiliary user input 328 is located essentially between the display screen 322 and the keyboard 332. In the illustrated embodiment, the non-directional auxiliary user input is a trackball 121. Motion of the trackball 121 can be assessed using a plurality of sensors that quantify rotational motion of the trackball 121 about axes intersecting with the trackball. Trackball 121 can also be configured to be depressable for purposes of selecting a function that is highlighted with a highlighting cursor. Also, it should be appreciated by those having skill in the art that other non-directionally limited auxiliary user input devices can be used in the place of the trackball, e.g., touchpads, joysticks and the like, and that handheld electronic device 300 can further comprise additional auxiliary inputs 350 for purposes of navigating highlighting cursor about the screen and/or for selecting highlighted functions.

Referring now to FIGS. 4a-4d, which illustrate display 302 of a handheld electronic device 300 as being smaller relative to the display 200 of a personal computer and further modified relative to display 252 of known device 250; an internet browser 304 is shown as displaying modified webpage 306, which has a plurality of user-actuable links 308 arranged thereabout, including horizontally and serially oriented user-actuable links 310 located toward a lower portion of the webpage and forming a first row 312 and a second row 314. For accommodation upon the minimized display of the handheld electronic device 300, the single row of user-actuable links from the native webpage 204 have been “wrapped” to form three rows, which appear to maintain a vertically relationship relative to one another. First row 312 is shown as consisting of horizontally and serially oriented user-actuable links 316 and 318, corresponding to “Press Releases” and “Developers” labels, respectively. Second row 314 is shown as consisting of horizontally and serially oriented user-actuable links 320, 322 and 324, corresponding to “Partners”, “Support” and “Careers” labels, respectively. Third row 315 is shown as consisting of horizontally and serially oriented selectable link 326, corresponding to “Legal” label.

As previously described, handheld electronic device 300 comprises a trackball 121 for navigating a highlighting cursor 328 amongst the plurality of user-actuable links 258. While user-actuable links 258 retain the horizontal and serial relationship of the native webpage 204, the application of the trackball 121, in combination with a processor preprogrammed determining the location of the various horizontally oriented and user-actuable links in a modified webpage, allows a user to directly navigate between rows without having to highlight each successive link in a row in order to pass to a neighboring row. As more clearly shown in FIGS. 4b-4d, if a user desires to navigate from the link 316, “Press Releases”, to the link 326, the user need merely apply a longitudinally directed rotational force upon the trackball 121 in the direction of the arrow. Upon applying such force, the highlighting cursor 328 is passed from the link 326 in the first row 312, to the link 322 in the second row 314. Continued rotation of the trackball in the direction of the arrow causes the highlighting cursor to travel to link 326 of the third row 316. Accordingly, the use of the trackball 121 with the handheld electronic device 300 provides a more efficient route for navigating a cursor between links which retain a horizontal and serial relationship from a native website.

Also, the device 300 can be configured such that the highlighting cursor can “skip” intermediately disposed user-actuable links on a modified webpage and navigate substantially directly to user-actuable links disposed at the top, bottom or sides of a webpage. For example, an additional auxiliary user input 350, which can comprise a button disposed near the bottom of the keyboard, or the “B” button to represent the term “bottom”, can be used to immediately move the highlighting cursor to a link at the bottom of the modified webpage. Similarly, a button disposed near the top of the keyboard, or the “T” button, for instance, to represent the term “top”, can be used to immediately move the highlighting cursor to a link at the top of the modified webpage. Similarly functioning buttons can be provided for moving the highlighting cursor to user-actuable links disposed at the sides of the modified webpage.

Further aspects of the environments, devices and methods of employment described hereinabove are expanded upon in the following details. An exemplary embodiment of the handheld electronic device 300 as shown in FIG. 1 is cradleable in the palm of a user's hand. The size of the device is such that a user is capable of operating the device 300 using the same hand that is holding the device 300. In a preferred embodiment, the user is capable of actuating all features of the device 300 using the thumb of the cradling hand; however, in other embodiments features may require the use of more than just the thumb of the cradling hand. The preferred embodiment of the handheld electronic device 300 features a keyboard on the face of the device 300, which is actuable by the thumb of the hand cradling the device 300. The user may also hold the device 300 in such a manner to enable two thumb typing on the device 300.

The handheld electronic device 300 includes an input portion and an output display portion. The output display portion can be a display screen 322, such as an LCD or other similar display device.

The input portion includes a plurality of keys that can be of a physical nature such as actuable buttons or they can be of a software nature, typically constituted by virtual representations of physical keys on a display screen (referred to herein as “software keys”). It is also contemplated that the user input can be provided as a combination of the two types of keys. Each key of the plurality of keys has at least one actuable action which can be the input of a character, a command or a function. In this context, “characters” are contemplated to exemplarily include alphabetic letters, language symbols, numbers, punctuation, insignias, icons, pictures, and even a blank space. Input commands and functions can include such things as delete, backspace, moving a cursor up, down, left or right, initiating an arithmetic function or command, initiating a command or function specific to an application program or feature in use, initiating a command or function programmed by the user and other such commands and functions that are well known to those persons skilled in the art. Specific keys or other types of input devices can be used to navigate through the various applications and features thereof Further, depending on the application or feature in use, specific keys can be enabled or disabled.

In the case of physical keys, all or a portion of the plurality of keys have one or more indicia, representing character(s), command(s), and/or functions(s), displayed at their top surface and/or on the surface of the area adjacent the respective key. In the instance where the indicia of a key's function is provided adjacent the key, the indicia can be printed on the device cover beside the key, or in the instance of keys located adjacent the display screen 322. Additionally, current indicia for the key may be temporarily shown nearby the key on the screen 322.

In the case of software keys, the indicia for the respective keys are shown on the display screen 322, which in one embodiment is enabled by touching the display screen 322, for example, with a stylus to generate the character or activate the indicated command or function. Some examples of display screens 322 capable of detecting a touch include resistive, capacitive, projected capacitive, infrared and surface acoustic wave (SAW) touchscreens.

Physical and software keys can be combined in many different ways as appreciated by those skilled in the art. In one embodiment, physical and software keys are combined such that the plurality of enabled keys for a particular application or feature of the handheld electronic device 300 is shown on the display screen 322 in the same configuration as the physical keys. Using this configuration, the user can select the appropriate physical key corresponding to what is shown on the display screen 322. Thus, the desired character, command or function is obtained by depressing the physical key corresponding to the character, command or function displayed at a corresponding position on the display screen 322, rather than touching the display screen 322.

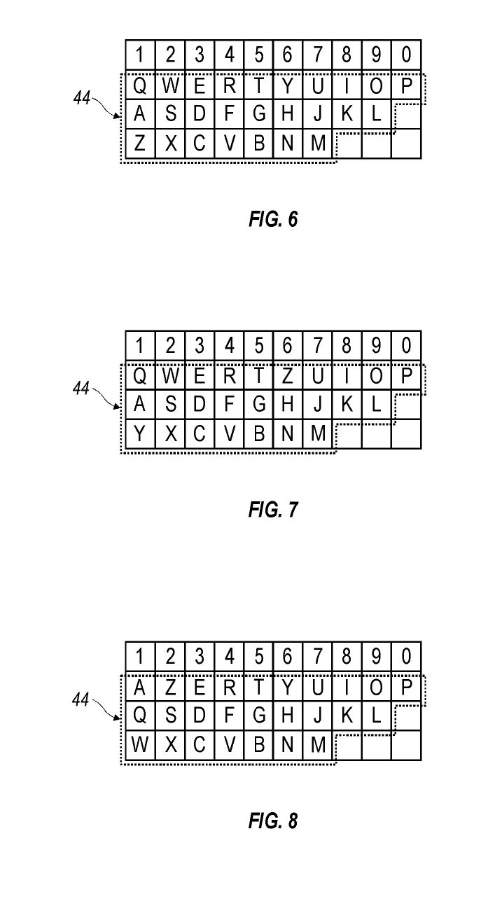

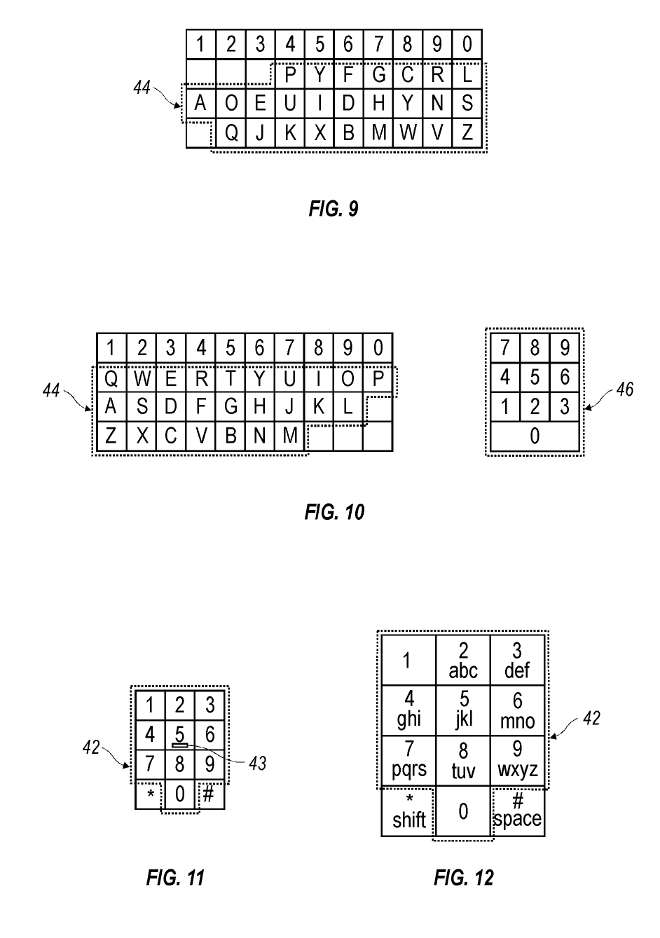

The various characters, commands and functions associated with keyboard typing in general are traditionally arranged using various conventions. The most common of these in the United States, for instance, is the QWERTY keyboard layout. Others include the QWERTZ, AZERTY, and Dvorak keyboard configurations. The QWERTY keyboard layout is the standard English-language alphabetic key arrangement 44 shown in FIG. 6. The QWERTZ keyboard layout is normally used in German-speaking regions; this alphabetic key arrangement 44 is shown in FIG. 7. The AZERTY keyboard layout 44 is normally used in French-speaking regions and is shown in FIG. 8. The Dvorak keyboard layout was designed to allow typists to type faster; this alphabetic key arrangement 44 is shown in FIG. 9.

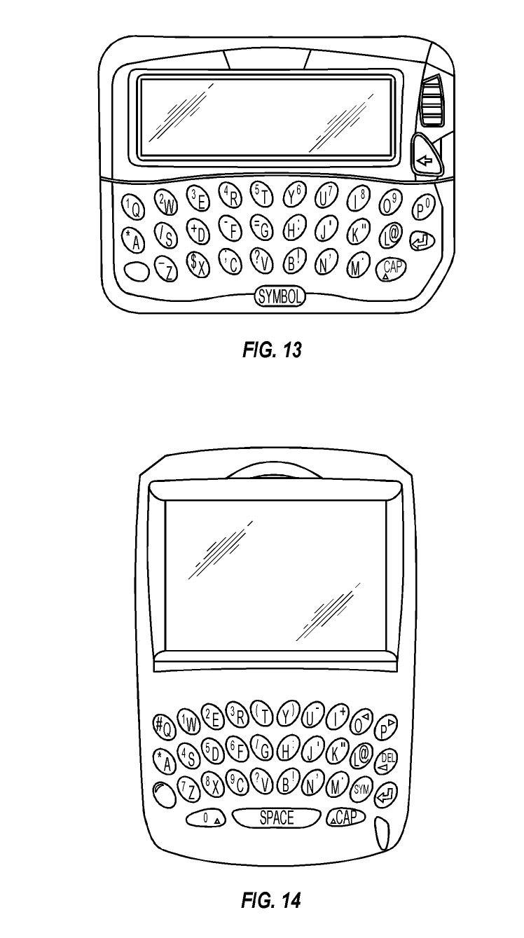

Alphabetic key arrangements are often presented along with numeric key arrangements. Typically, the numbers 1-9 and 0 are positioned in the row above the alphabetic keys 44, as shown in FIGS. 6-9. Alternatively, the numbers share keys with the alphabetic characters, such as the top row of the QWERTY keyboard (see FIG. 13 for an example). Yet another exemplary numeric key arrangement is shown in FIG. 10, where a “ten-key” style numeric keypad 46 is provided on a separate set of keys that is spaced from the alphabetic/numeric key arrangement 44. The ten-key styled numeric keypad 46 includes the numbers “7”, “8”, “9” arranged in a top row, “4”, “5”, “6” arranged in a second row, “1”, “2”, “3” arranged in a third row, and “0” in a bottom row. Further, a numeric phone key arrangement 42 is exemplarily illustrated in FIG. 11.

As shown in FIG. 11, the numeric phone key arrangement 42 may also utilize a surface treatment on the surface of the center “5” key. This surface treatment is configured such that the top surface of the key is distinctive from the surface of other keys. Preferably the surface treatment is in the form of a raised bump or recessed dimple 43. Alternatively, raised bumps may be positioned on the housing around the “5” key and do not necessarily have to be positioned directly on the key.

It is desirable for handheld electronic devices 300 to include a combined text-entry keyboard and a telephony keyboard. Examples of such mobile communication devices 300 include mobile stations, cellular telephones, wireless personal digital assistants (PDAs), two-way paging devices, and others. Various keyboards are used with such devices and can be termed a full keyboard, a reduced keyboard, or phone key pad.

In embodiments of a handheld electronic device 300 having a full keyboard, the alphabetic characters are singly associated with the plurality of physical keys. Thus, in an English-language keyboard of this configuration, there are at least 26 keys in the plurality so that there is at least one key for each letter.

Devices 300 incorporating full keyboards for the alphabetic characters are shown in FIGS. 13 and 14. While both devices feature numeric keys, the device shown in FIG. 13 incorporates the numeric keys in a single row, whereas the device of FIG. 14 features numeric keys arranged according to the ITU Standard E.161 as shown in FIG. 11. The latter numeric arrangement can be described as an overlaid numeric phone keypad arrangement.

As intimated above, in order to further reduce the size of a handheld electronic device 300 without making the physical keys or software keys too small, some handheld electronic devices 300 use a reduced keyboard, where more than one character/command/function is associated with each of at least a portion of the plurality of keys. This results in certain keys being ambiguous since more than one character is represented by or associated with the key, even though only one of those characters is typically intended by the user when activating the key.

Thus, certain software usually runs on the processor of these types of handheld electronic device 300 to determine or predict what letter or word has been intended by the user. Some examples of software include predictive text routines which typically include a disambiguation engine and/or predictive editor application. The software preferably also has the ability to recognize character letter sequences that are common to the particular language, such as, in the case of English, words ending in “ing.” Such systems can also “learn” the typing style of the user making note of frequently used words to increase the predictive aspect of the software. Other types of predictive text computer programs may be utilized with the reduced keyboard arrangements described herein, without limitation. Some specific examples include the multi-tap method of character selection and “text on nine keys”.

The keys of reduced keyboards are laid out with various arrangements of characters, commands and functions associated therewith. In regards to alphabetic characters, the different keyboard layouts identified above are selectively used based on a user's preference and familiarity; for example, the QWERTY keyboard layout is most often used by English speakers who have become accustomed to the key arrangement.

FIG. 1 shows a handheld electronic device 300 that carries an example of a reduced keyboard using the QWERTY keyboard layout on a physical keyboard array of twenty keys comprising five columns and four rows. Fourteen keys are used for alphabetic characters and ten keys are used for numbers. Nine of the ten numbers share a key with alphabetic characters. The “space” key and the number “0” share the same key, which is centered on the device and centered below the remainder of the numbers on the keyboard 332. While in other embodiments, the number “0” may be located on other keys.

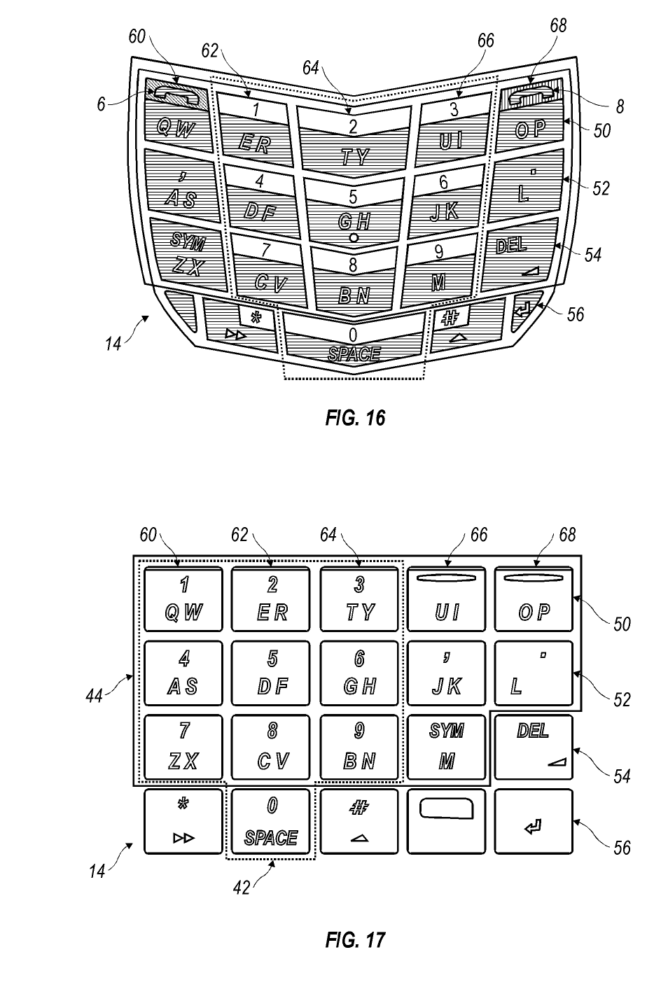

FIG. 16 shows an example physical keyboard array of 20 keys composed of five columns and four rows. Fourteen keys on the keyboard 332 are associated with alphabetic characters and ten keys are associated with numbers. Many of the keys have different sizes than the other keys, and the rows are non-linear. In particular, the keys in the middle column 64 are wider than keys in the outer columns 60, 62, 66 and 68. To readily identify the phone user interface (the second user interface), the numeric phone keys 0-9 include a color scheme that is different from that of the remaining keys associated with the QWERTY key arrangement.

In this example, a color scheme of the numeric phone keys has a two tone appearance, with the upper portion of the numeric keys being a first color and the lower portion of the numeric keys being a second color. The first color may be lighter than the second color, or darker than the second color. Furthermore, the send key 6 and end key 8 are located on keys with alphabetic indicia have a background color and/or color of the symbols that are different from the other keys of the keyboard 332.

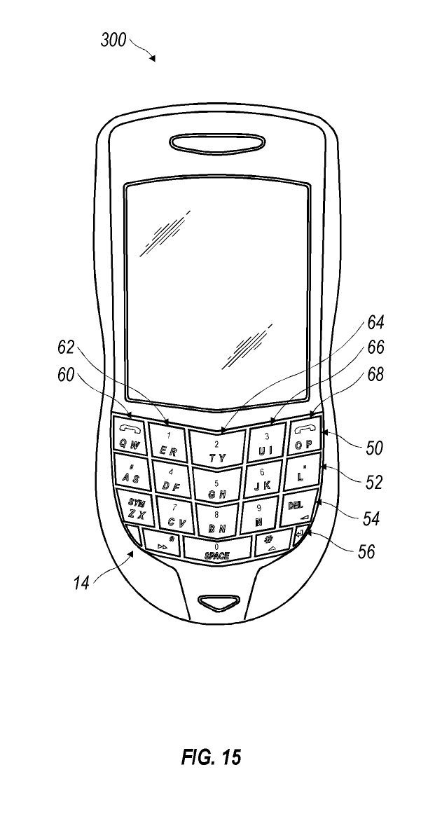

FIG. 17 shows a similar format for the reduced QWERTY arrangement of alphabetic characters 44 as presented in FIG. 15, but the numeric phone key arrangement 42 is positioned in the first 60, second 62, and third 64 columns instead of being centered on the keyboard 332. Thus, no numerals are presented on keys in the fourth 66 and fifth 68 columns. The first row 50 of keys includes in order the following key combinations for the text entry and telephony mode: “QW/1”, “ER/2”, “TY/3”, “UI”, and “OP”. The second row 52 includes the following key combinations in order: “AS/4”, “DF/5”, “GH/6”, “JK/,”, and “L/.” The third row 54 includes the following key combinations in order: “ZX/7”, “CV/8”, “BN/9”, “M/sym” and “backspace/delete”. The fourth row 56 includes the following key combinations in order: “next/*”, “space/0”, “shift/#”, “alt” and “return/enter”. The keys in each of the rows are of uniform size and the rows and columns are straight.

Another embodiment of a reduced alphabetic keyboard is found on a standard phone keypad. Most handheld electronic devices having a phone key pad also typically include alphabetic key arrangements overlaying or coinciding with the numeric keys as shown in FIG. 12. Such alphanumeric phone keypads are used in many, if not most, traditional handheld telephony mobile communication devices such as cellular handsets.

As described above, the International Telecommunications Union (“ITU”) has established phone standards for the arrangement of alphanumeric keys. The standard phone numeric key arrangement shown in FIGS. 11 (no alphabetic letters) and 12 (with alphabetic letters) corresponds to ITU Standard E.161, entitled “Arrangement of Digits, Letters, and Symbols on Telephones and Other Devices That Can Be Used for Gaining Access to a Telephone Network.” This standard is also known as ANSI TI. 703-1995/1999 and ISO/IEC 9995-8:1994. Regarding the numeric arrangement, it can be aptly described as a top-to-bottom ascending order three-by-three-over-zero pattern.

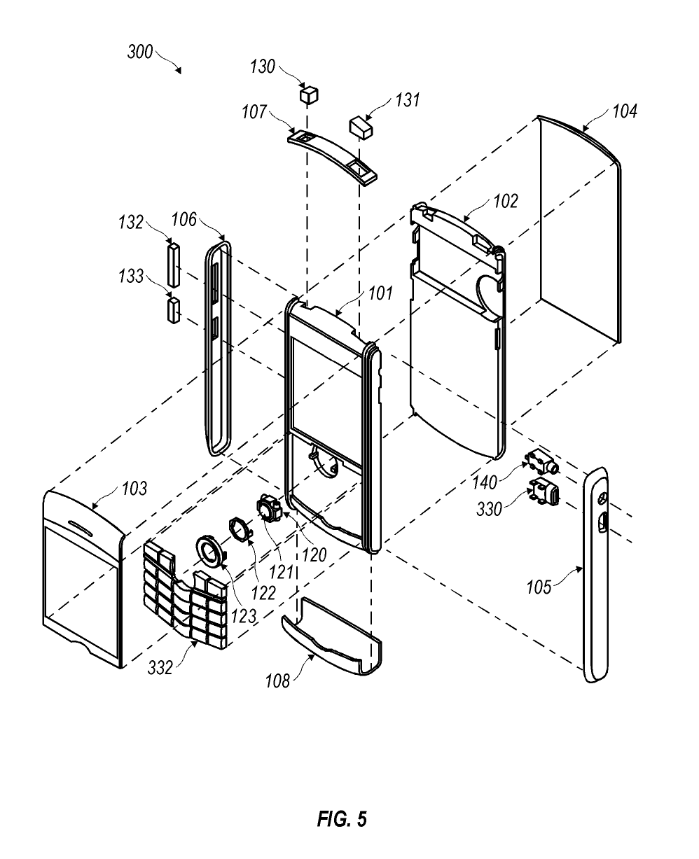

FIG. 5 is an exploded view showing some of the typical components found in the assembly of the handheld electronic device. The construction of the device benefits from various manufacturing simplifications. The internal components are constructed on a single PCB (printed circuit board) 102. The keyboard 332 is constructed from a single piece of material, and in a preferred embodiment is made from plastic. The keyboard 332 sits over dome switches (not shown) located on the PCB 102 in a preferred embodiment. One switch is provided for every key on the keyboard in the preferred embodiment, but in other embodiments more than one switch or less than one switch per key are possible configurations. The support frame 101 holds the keyboard 332 and navigation tool 328 in place above the PCB 102. The support frame 101 also provides an attachment point for the display (not shown). A lens 103 covers the display to prevent damage. When assembled, the support frame 101 and the PCB 102 are fixably attached to each other and the display is positioned between the PCB 102 and support frame 101.

The navigation tool 328 is frictionally engaged with the support frame 101, but in a preferred embodiment the navigation tool 328 is removable when the device is assembled. This allows for replacement of the navigation tool 328 if/when it becomes damaged or the user desires replacement with a different type of navigation tool 328. In the exemplary embodiment of FIG. 3, the navigation tool 328 is a ball 121 based device. Other navigation tools 328 such as joysticks, four-way cursors, or touch pads are also considered to be within the scope of this disclosure. When the navigation tool 328 has a ball 121, the ball 121 itself can be removed without removal of the navigation tool 328. The removal of the ball 121 is enabled through the use of an outer removable ring 123 and an inner removable ring 122. These rings 122, 123 ensure that the navigation tool 328 and the ball 121 are properly held in place against the support frame 101.

A serial port (preferably a Universal Serial Bus port) 330 and an earphone jack 140 are fixably attached to the PCB 102 and further held in place by right side element 105. Buttons 130-133 are attached to switches (not shown), which are connected to the PCB 102.

Final assembly involves placing the top piece 107 and bottom piece 108 in contact with support frame 101. Furthermore, the assembly interconnects right side element 105 and left side element 106 with the support frame 101, PCB 102, and lens 103. These side elements 106, 105 provide additional protection and strength to the support structure of the device 300. In a preferred embodiment, backplate 104 is removably attached to the other elements of the device.

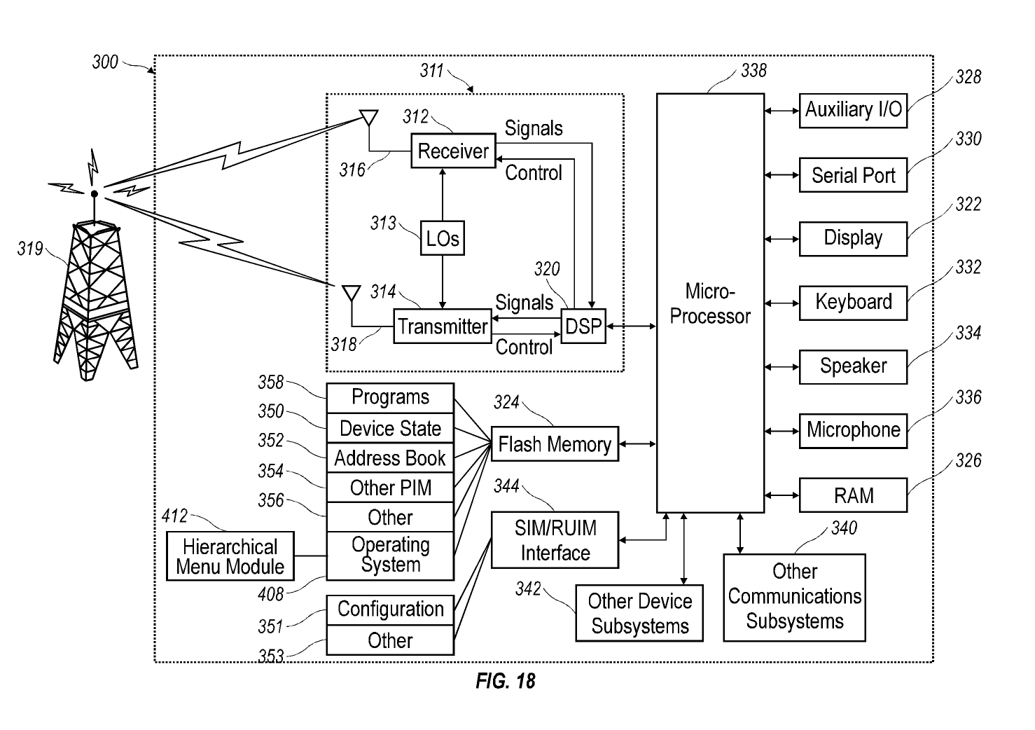

An exemplary handheld electronic device 300 and its cooperation in a wireless network 319 is exemplified in the block diagram of FIG. 18. This figure is exemplary only, and those persons skilled in the art will appreciate the additional elements and modifications necessary to make the device 300 work in particular network environments.

The block diagram of FIG. 18 representing the communication device 300 interacting in the communication network 319 shows the device's 300 inclusion of a microprocessor 338 which controls the operation of the device 300. The communication subsystem 311 performs all communication transmission and reception with the wireless network 319. The microprocessor 338 further connects with an auxiliary input/output (I/O) subsystem 328, a serial port (preferably a Universal Serial Bus port) 330, a display 322, a keyboard 332, a speaker 334, a microphone 336, random access memory (RAM) 326, and flash memory 324. Other communication subsystems 340 and other device subsystems 342 are generally indicated as connected to the microprocessor 338 as well. An example of a communication subsystem 340 is that of a short range communication subsystem such as BLUETOOTH® communication module or an infrared device and associated circuits and components. Additionally, the microprocessor 338 is able to perform operating system functions and preferably enables execution of software applications on the communication device 300.

The above described auxiliary I/O subsystem 328 can take a variety of different subsystems including the above described navigation tool. The navigation tool is preferably a trackball based device, but it can be a thumbwheel, navigation pad, or joystick. These navigation tools are preferably located on the front surface of the device 300 but may be located on an exterior surface of the device 300. Other auxiliary I/O devices can include external display devices and externally connected keyboards (not shown). While the above examples have been provided in relation to the auxiliary I/O subsystem, other subsystems capable of providing input or receiving output from the handheld electronic device 300 are considered within the scope of this disclosure. Additionally, other keys may be placed along the side of the device 300 to function as escape keys, volume control keys, scrolling keys, power switches, or user programmable keys, which may be programmed accordingly.

In an exemplary embodiment, the flash memory 324 is enabled to provide a storage location for the operating system, device programs, and data. While the operating system in a preferred embodiment is stored in flash memory 324, the operating system in other embodiments is stored in read-only memory (ROM) or similar storage element (not shown). As those skilled in the art will appreciate, the operating system, device application or parts thereof may be loaded in RAM 326 or other volatile memory.

In a preferred embodiment, the flash memory 324 contains programs/applications 358 for execution on the device 300 including an address book 352, a personal information manager (PIM) 354, and the device state 350. Furthermore, programs 358 and other information 356 including data can be segregated upon storage in the flash memory 324 of the device 300.

When the device 300 is enabled for two-way communication within the wireless communication network 319, it can send and receive signals from a mobile communication service. Examples of communication systems enabled for two-way communication include, but are not limited to, the GPRS (General Packet Radio Service) network, the UMTS (Universal Mobile Telecommunication Service) network, the EDGE (Enhanced Data for Global Evolution) network, and the CDMA (Code Division Multiple Access) network and those networks generally described as packet-switched, narrowband, data-only technologies mainly used for short burst wireless data transfer. For the systems listed above, the communication device 300 must be properly enabled to transmit and receive signals from the communication network 319. Other systems may not require such identifying information. GPRS, UMTS, and EDGE require the use of a SIM (Subscriber Identity Module) in order to allow communication with the communication network 319. Likewise, most CDMA systems require the use of a RUIM (Removable Identity Module) in order to communicate with the CDMA network. The RUIM and SIM card can be used in multiple different communication devices 300. The communication device 300 may be able to operate some features without a SIM/RUIM card, but it will not be able to communicate with the network 319. A SIM/RUIM interface 344 located within the device allows for removal or insertion of a SIM/RUIM card (not shown). The SIM/RUIM card features memory and holds key configurations 351, and other information 353 such as identification and subscriber related information. With a properly enabled communication device 300, two-way communication between the communication device 300 and communication network 319 is possible.

If the communication device 300 is enabled as described above or the communication network 319 does not require such enablement, the two-way communication enabled device 300 is able to both transmit and receive information from the communication network 319. The transfer of communication can be from the device 300 or to the device 300. In order to communicate with the communication network 319, the device 300 in a preferred embodiment is equipped with an integral or internal antenna 318 for transmitting signals to the communication network 319. Likewise the communication device 300 in the preferred embodiment is equipped with another antenna 316 for receiving communication from the communication network 319. These antennae (316, 318) in another preferred embodiment are combined into a single antenna (not shown). As one skilled in the art would appreciate, the antenna or antennae (316, 318) in another embodiment are externally mounted on the device 300.

When equipped for two-way communication, the communication device 300 features a communication subsystem 311. As is well known in the art, this communication subsystem 311 is modified so that it can support the operational needs of the device 300. The subsystem 311 includes a transmitter 314 and receiver 312 including the associated antenna or antennae (316, 318) as described above, local oscillators (LOs) 313, and a processing module 320 which in a preferred embodiment is a digital signal processor (DSP) 320.

It is contemplated that communication by the device 300 with the wireless network 319 can be any type of communication that both the wireless network 319 and device 300 are enabled to transmit, receive and process. In general, these can be classified as voice and data. Voice communication is communication in which signals for audible sounds are transmitted by the device 300 through the communication network 319. Data is all other types of communication that the device 300 is capable of performing within the constraints of the wireless network 319.

Exemplary embodiments have been described hereinabove regarding both handheld electronic devices, as well as the communication networks within which they cooperate. It should be appreciated, however, that a focus of the present disclosure is on enabling a user to directly navigate a highlighting cursor between rows of horizontal and serially oriented links on a modified webpage using a non-directionally limited auxiliary user input.

What is claimed is:

1. A handheld communication device programmed to permit substantially vertical user navigation on a display screen of the device across a plurality of serially associated, user-actuable links without progressing sequentially through said series of user-actuable links, said device comprising:
a display screen, having a width and a height suitable for accommodating textual input to the handheld communication device;
a processor programmed to display on the display screen a viewable page comprising a plurality of serially associated user-actuable links, said serially associated user-actuable links having a display length greater than the width of the display screen and said processor programmed to wrap the user-actuable links into a plurality of vertically stacked link segments that at least partially fit on the display screen for user viewing and actuation; and
an auxiliary user input device capable of directing two-dimensional navigation of a cursor on said display screen and said processor programmed to direct substantially vertical navigation of the cursor between vertically stacked, user-actuable links in response to a corresponding user request, input via the auxiliary user input device, without progressing the cursor sequentially through said series of user-actuable links.

2. The handheld communication device as recited in claim 1, wherein said auxiliary user input is a trackball.

3. The handheld communication device as recited in claim 1 wherein said user-actuable links are functionally horizontally serially associated with one another.

4. The handheld communication device as recited in claim 3 wherein said serially associated links are arranged in vertical appearing relationship.

5. The handheld communication device as recited in claim 4, wherein said substantially vertical navigation is accomplished by asserting a longitudinally directed force upon said auxiliary user input device.

6. The handheld communication device as recited in claim 5, comprising an additional auxiliary input for accomplishing said substantially vertical navigation.

7. The handheld communication device as recited in claim 6, wherein said additional auxiliary input is disposed proximate at least one of a top and bottom of said keyboard of said handheld communication device.

8. The handheld communication device as recited in claim 7, wherein said additional auxiliary input is a keyboard button.

9. The handheld communication device as recited in claim 8, wherein said keyboard button is one of keyboard button labeled “T” and “B.”

10. A method for affecting substantially vertical user navigation on a display screen of an electronic handheld device across a plurality of serially associated, user-actuable links without progressing sequentially through said series of user-actuable links, said electronic handheld device comprising a display screen, having a width and a height, located above a keyboard that is suitable for accommodating textual input to the handheld communication device, said method comprising:
programming a processor to display on the display screen, a viewable page comprising a plurality of serially associated user-actuable links, said serially associated user-actuable links having a display length greater than the width of the display screen, said programmed processor wrapping the user-actuable links into a plurality of vertically stacked link segments that at least partially fit on the display screen for user viewing and actuation; and
inputting a navigation request using an auxiliary user input device to direct two-dimensional navigation of a cursor on said display screen, said programmed processor directing substantial vertical navigation of said cursor between said vertically stacked, user-actuable links in response to a said input, said two-dimensional navigation occurring without progressing sequentially through said series of user-actuable links.

11. The method as recited in claim 10, wherein said auxiliary user input is a trackball.

12. The method as recited in claim 10 wherein said user-actuable links are functionally horizontally serially associated with one another.

13. The method as recited in claim 12 wherein said functionally horizontally serially associated links are arranged in vertical appearing relationship.

14. The method as recited in claim 13, wherein said substantially vertical navigation is accomplished by asserting a longitudinally directed force upon said auxiliary user input device.

15. The method as recited in claim 14, comprising an additional auxiliary input for accomplishing said substantially vertical navigation.

16. The method as recited in claim 15, wherein said additional auxiliary input is disposed proximate at least one of a top and bottom of said keyboard of said handheld communication device.

17. The method as recited in claim 16, wherein said additional auxiliary input is a keyboard button.

18. The method as recited in claim 17, wherein said keyboard button is one of keyboard button labeled “T” and “B.”
